(19) United States
(12) Patent Application Publication
(10) Pub. No.: US 2025/0333990 A1
(43) Pub. Date: Oct. 30, 2025

(54) SPRING HINGE EQUIPPED WITH AN ASSEMBLY TOOL

(71) Applicant: ELESA S.P.A., Milano (IT)

(72) Inventor: Alberto Bertani, Milano (IT)

(21) Appl. No.: 19/183,151

(22) Filed: Apr. 18, 2025

(30) Foreign Application Priority Data
Apr. 30, 2024 (IT) 102024000009817

(51) Int. Cl. E05F 1/12; E05F 7/00

(52) U.S. Cl. CPC E05F 1/1207; E05F 7/005; E05Y 2900/20

(57) ABSTRACT

A hinge of the type including two coaxial, overlapping constitutive wings, each of the constitutive wings being constituted by a body having an ogive profile in which a cavity is internally obtained, wherein one of the constitutive wings carries a pin of smaller diameter in a stable engagement inside the cavity, surrounded by a spring, the pivot and the spring being suitable for engagement with the cavity of the other constituent wing, the coaxial constituent wings having on the base surface of the internal cavity a tangential groove for housing the terminal appendage of the spring.

### CROSS REFERENCE TO RELATED APPLICATIONS

This application claims the priority of Italian Patent Application No. 102024000009817, filed on Apr. 30, 2024, which is incorporated herein by reference in its entirety.

### FIELD OF THE INVENTION

The present invention relates to a hinge, in particular a spring-loaded hinge for moving doors in respect of a frame.

### BACKGROUND OF THE INVENTION

These components are typically used in industrial machines, e.g. for connecting the goods of mechanical equipment to the chassis, or the doors to vending machines, electrical cabinets, banking devices, or in protective casings, access gates or similar.

Differently from common hinges, this type of product is intended to ensure a stable position of the door in relation to the frame, unless a force is applied to the door that is opposite to that which ensures that the door is held in the desired position.

Typically, it is planned to insert a spring body associated with the internal pin connecting the two constituent wings of the hinge itself, the ends of said spring body being arranged within cavities on the bodies fixed to the frame and door respectively, in order to correctly define the relative positions of the two elements.

The hinges available on the market today work excellently if there are conventional situations, but they encounter many problems when they have to be fitted on boxed uprights, for which a substantially offset assembly is required, so that there is the correct arrangement of the panel with respect to the upright in the rest (or pre-loaded) position and the alignment when the panel is in the open (or loaded) position. In this regard, it is necessary to highlight the non-trivial problem for the installer that the hinge spring must, during assembly, be pre-loaded to allow the hatch to remain closed when at rest.

### BRIEF SUMMARY OF THE INVENTION

It is therefore object of the present invention to realize a spring-loaded hinge apt to return a panel to a predefined position with respect to a box upright, in which the mounting is quick and the hinge is perfectly aligned with the strut, so that the panel is flush with the frame structure when in the operating position and that there are no errors of movement when the panel has to move from one stable position to another.

Said object is obtained by means of a hinge of the type composed of two coaxial and overlapping constituent wings, each of said constituent wings being constituted by a body having an ogive profile in which a cavity is internally obtained, wherein one of said constituent wings carries a pin of smaller diameter in a stable engagement inside said cavity, surrounded by a spring, said pivot and said spring being suitable for engagement with the cavity of said other constituent wing, said coaxial constituent wings having on the base surface of said internal cavity a tangential groove for housing the terminal appendage of said spring.

It is a further object of the present invention to provide a tool associated with said hinge which allows the installer to proceed quickly, accurately and expeditiously with the assembly of said hinge to the structure to which it is to be attached, in order to make the assembly and adjustment fast on the one hand, and on the other hand to have certain it of the perfect alignment of the two constituent wings to the components of the machine to be connected and consequently of the movement of one element with respect to the other.

Said object is obtained by means of a hinge of the type composed of two coaxial and overlapping constituent wings, one of said constituent wings being constituted by an internally hollow ogive body, the other of said constituent wings being constituted by a cylindrical body from one end of which a pin of smaller diameter extends, characterised by said constituent wings being further provided with an assembly tool constituted by a substantially C-shaped body, from one of the short sides of said “C” vertically extending—for about half a height—a pair of supporting walls as high as one of said constituent wings.

Other advantages and preferred features will be the subject of secondary claims.

### BRIEF DESCRIPTION OF THE DRAWINGS

The invention is now described with reference to a preferred embodiment with accompanying drawings, a brief description of which is given below to aid understanding.

FIG. 1 is an exploded view of the hinge according to the invention, one constituent wing being rotated 90° in respect of to the other;

FIG. 2 is a sectional view of the exploded view of FIG. 1 with the constituent wings aligned;

FIG. 3 is the rear view of the hinge according to the invention with the constituent wings aligned;

FIG. 4 is a sectional view of the hinge in FIG. 3;

FIGS. 5a and 5b show the detail of one of the opposing appendages of the spring, according to the two different embodiments, dextrorotatory and levorotatory;

FIGS. 6a and 6b are the views of the hinge ready for installation, FIG. 6a being the front view of the first constituent element and side view of the second constituent element, FIG. 6b being the mirror image, with the front view of the second constituent element and side view of the second constituent element

FIGS. 7a to 7f show the hinge mounted on the tool according to the invention in the various assembly stages provided;

FIG. 8 is a view of an assembled hinge.

### DESCRIPTION OF EXAMPLE EMBODIMENTS

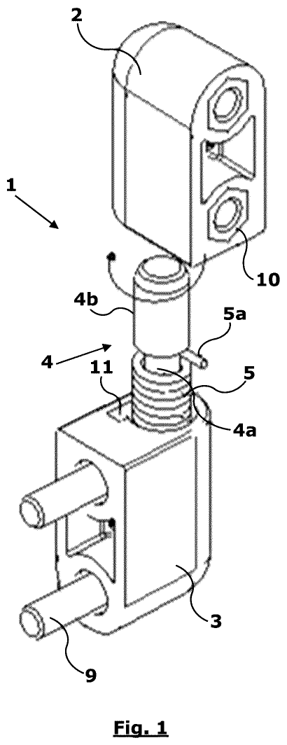

As illustrated in FIG. 1, the hinge 1 according to the invention comprises two coaxial and overlapping constituent wings 2, 3, each having a substantially ogive profile. From one of said constitutive wings protrudes a pivot 4, surrounded by a spring 5. More precisely, the pivot 4 comprises a main body 4a and a larger diameter head 4b, the head 4b delimiting the expansion area of the spring 5.

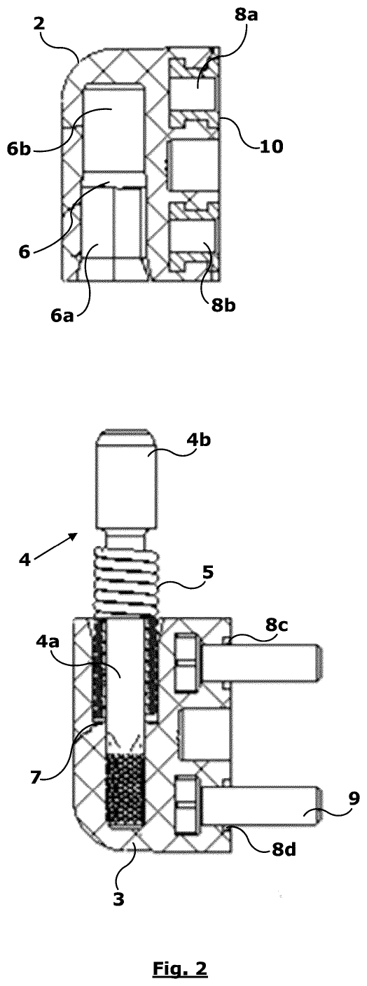

FIGS. 2 to 4 show the internal structure of said constituent wings: the ogive body of wing 2 has a cavity 6 within it shaped for housing the end portion of said pin 4 and of said spring 5, while the ogive body of wing 3 has a cavity 7 apt to house the base portion of said pin 4 and part of said spring 5. More precisely, pin 4 is embedded in its terminal portion within the base of said constituent wing 3, while a central portion of said pin 4 and about half of said spring 5 are accommodated within said cavity 7.

In order to facilitate the housing of the spring 5 and to allow the correct movement of one constituent wing with respect to the other, the cavity 6 has two distinct chambers, the upper chamber 6b having a slightly smaller diameter than the lower chamber 6a.

On the sides, two pairs of cavities 8a, 8b, 8c, 8d are provided to accommodate studs 9, preferably in nickel-plated steel, and threaded bushings 10 in brass, respectively.

In addition, a tangential groove 11 is provided at the contact surface between each of said coaxial constituent wings 2,3 and said spring 5.

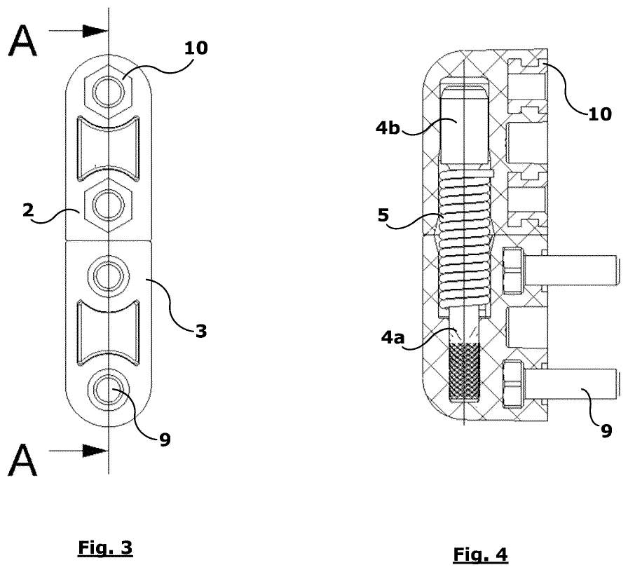

From FIGS. 5a and 5b, in fact, we recognise that the spring body is configured in such a way as to provide at the terminal end of its coils an appendix 5a, mentioned above, which assumes the function of defining the angle of rotation of the hinge—whether right-turning or left-turning—and consequently identifying the reciprocal position of rest and maximum charge of the wing attached to the hinge with respect to the wing attached to the frame.

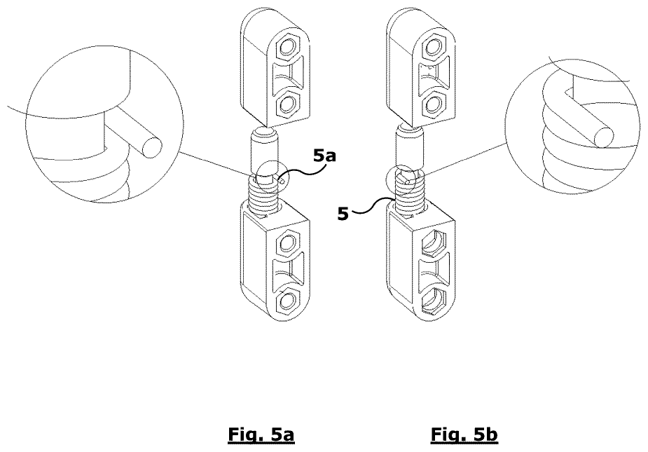

As shown in FIGS. 6a and 6b, in fact, when the hinge is in the operational phase, the two constituent wings are offset by 90°.

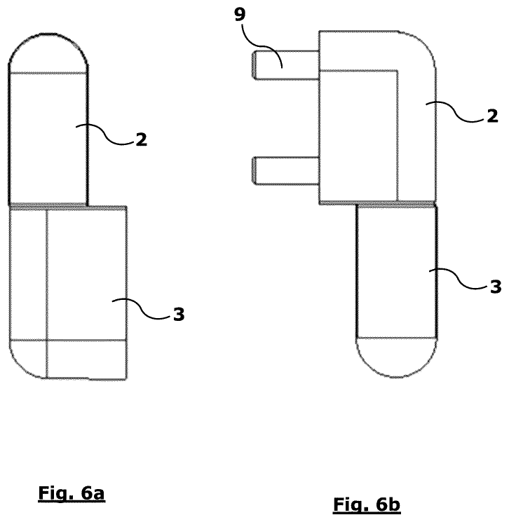

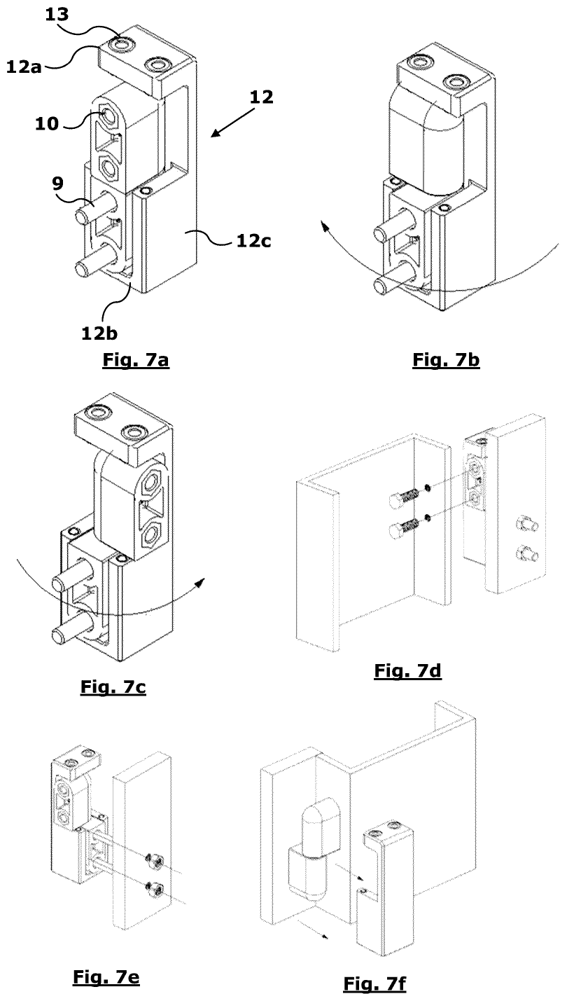

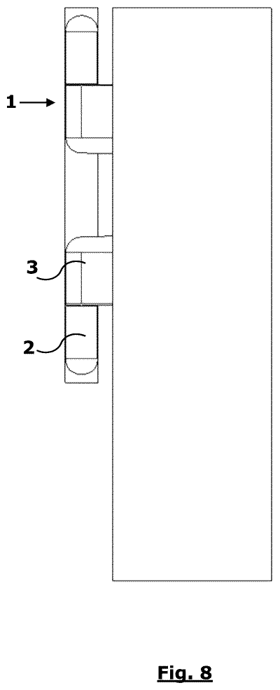

Moreover, as is well illustrated in FIGS. 7a to 7f, there is provided an assembly tool 12 comprising a substantially “C”-shaped body, from one of the short sides of said “C” vertically departing—for about half a height—a pair of support walls 12a as high as one of said constituent wings, the base walls 12b and head walls 12c of said tool acting as support walls for the opposite ends of said constituent wings 2, 3.

FIGS. 7a to 7f and FIG. 8 provide a better understanding of the assembly and operation of the hinge according to the invention.

The operator takes care to place the hinge inside the “C” tool 12, the two wings (FIG. 7a) being aligned. After mounting the hinge in the tool 12, the operator takes care to rotate it 90° in a leviturn (FIG. 7b) or dextroroturn (FIG. 7c) rotation, so as to bring the spring into a preloaded condition. A pair of pushers 13, provided on at least one of the two walls 12a, 12b at the base and head, keeps the hinge in a preloaded position and ready for installation.

At this point, the operator takes care to secure the studs on the upright side (FIG. 7d), associating them with conventional sealing nuts, possibly combined with washers to protect the panel itself.

Once this operation has been completed, it is time to fasten—by means of through-bolting—the panel to the hinge, screwing screws into the galvanised bushings provided on the constituent wing that remains free (FIG. 7e).

Once the screwing operations have been completed, the tool can be pulled (FIG. 7f), leaving the hinge free to operate in the conventional manner.

As finally illustrated in FIG. 8, this results in a sober and elegant hinge, which guarantees perfect tightness and precise alignment, without excessive difficulties in measuring and further checks after assembly.

Therefore, the desired objects were achieved, i.e. to produce a hinge with a quick assembly, and perfect alignment with the upright, so that the panel is flush with the frame structure when in the operating position and that there are no movement imperfections when the panel has to move from one stable position to another, and at the same time a tool to ensure that the assembly of the hinge is indeed quick and precise.

As is well understood, the above description concerns a specific preferred form of embodiment. Various may be modifications to the solution now described that do not depart from the scope of protection of the invention, as defined by the attached set of claims.

In particular, the description concerned a specific and paradigmatic form of execution, but various configurations can be envisaged. For example, the constitutive wings can appear in their initial state, i.e. when the spring is at rest, in various states: parallel, offset by 90° or by another angle depending on the preload force to be imposed when the door is closed. Obviously, the relative position of the wings will be different from that illustrated in the figure depending on the preloading angles envisaged, with an essentially infinite number of embodiments foreseeable.

To confirm the above, FIG. 7 shows a ‘C’-shaped tool 12, with the two wings aligned: in the case of different angles of the hinge being preloaded, the tool—thanks to the pushers 13—maintains the desired angle, while the operator completes by attaching the wings to the machine body elements.

Similarly, in the course of the description, it was envisaged that the hinge would be secured by a pair of bushings and a pair of studs. Nothing would change, in substance, if one had opted for two pairs of bushings or two pairs of studs: these would in fact be different variants of the same innovative solution.

1. Hinge of the type composed of two coaxial, overlapping constitutive wings, each of said constitutive wings being constituted by a body having an ogive profile in which a cavity is internally obtained, wherein one of said constitutive wings carries a pin of smaller diameter in a stable engagement inside said cavity, surrounded by a spring, said pivot and said spring being suitable for engagement with the cavity of said other constituent wing, said coaxial constituent wings having on the base surface of said internal cavity a tangential groove for housing the terminal appendage of said spring.

2. The hinge of claim 1, wherein holes are provided on a rear surface to accommodate means of engagement with the walls to which said hinge is to be fixed.

3. The hinge of claim 2, wherein these engagement means comprise at least one of threaded bushings and threaded studs respectively.

4. The hinge of claim 3, wherein said threaded bushings are provided on one constituent wing and said threaded studs are on the other constituent wing.

5. The hinge of claim 3, wherein said studs are provided on both constituent wings.

6. The hinge of claim 3, wherein said bushings are provided on both constituent wings.

7. The hinge of claim 3, wherein said threaded bushings are made of brass and said threaded studs are made of nickel-plated steel.

8. The hinge of claim 1, wherein said pin comprises a main body and a head of larger diameter, the head delimiting the expansion area of said spring.

9. The hinge of claim 1, further provided with an assembly tool constituted by a substantially C-shaped body, from one of the short sides of said “C” vertically departing, for about half a height, a pair of support walls as high as one of said constituent wings, the base and head walls of said tool acting as support walls for the opposite ends of said constituent wings.

10. The hinge of claim 9, wherein on at least one of said base and head walls there are pushers for maintaining the relative position of one wing with respect to the other.
